(19) United States
(12) Patent Application Publication
(10) Pub. No.: US 2004/0182455 A1
(43) Pub. Date: Sep. 23, 2004

(54) Dual body service valve

(76) Inventors: Michael P. Wells, New Haven, IN (US); Nazih Khatib, Ft. Wayne, IN (US)

Correspondence Address: Joseph J. Pophal, PARKER-HANNIFIN CORPORATION, 6035 Parkland Boulevard, Cleveland, OH, 44124-4141, US

(21) Appl. No.: 10/766,445

(22) Filed: Jan. 28, 2004

Related U.S. Application Data
(60) Provisional application No. 60/453,658, filed on Mar. 10, 2003.

(51) Int. Cl. F16K 11/20

(52) U.S. Cl. 137/594

(57) ABSTRACT

A service valve assembly, for use in a split air conditioning/heat pump system, with a single valve block having a plurality of passages, a first valve and a second valve. The assembly includes a first cavity within the block with a first valve holding passage, for conducting gaseous refrigerant inside the valve block. The first valve includes a first through passage radially extending both through the first valve as well as from an outer surface of a first side of the block to an outer surface of a side opposite the first side. A first charging passage extends from the valve block outer surface to the first through passage. The valve block also includes a second cavity, including a second valve holding passage, for conducting liquid refrigerant within the block. The second valve includes a second through passage extending both through the second valve as well as from the outer surface of the valve block first side to the outer surface of the opposite side. A second charging passage extends from the valve block outer surface to the second through passage.

### CROSS-REFERENCE TO RELATED CASES

The present application claims the benefit of the filing date of U.S. Provisional Application Serial No. 60/453,658; filed Mar. 10, 2003, the disclosure of which is expressly incorporated herein by reference.

### FIELD OF THE INVENTION

The present invention relates to a service valve assembly, for use in a split air conditioning/heat pump system, having a single valve block with a plurality of passages, a first valve and a second valve, for connecting an outdoor unit with an indoor unit.

### BACKGROUND OF THE INVENTION

A condensing unit is a key component of a split residential air-conditioning and heat pump system. The condensing unit is primarily comprised of a compressor, an outdoor coil, an outdoor fan, and line connections. As is well known in the art, during installation of the system, the condensing unit, or outdoor unit, is connected to two lines (high pressure and low pressures sides) that convey refrigerant to and from an indoor unit, primarily comprised of an indoor coil, an indoor fan and an expansion device. These two connections on the condensing unit are made at liquid (high side) and suction (low side) service valves. Service valves provide for shutoffs of connections between the outdoor and indoor units and contain ports for charging and measuring system pressures.

The service valves are initially shut off in order to retain original factory or recently charged refrigerant in an outdoor unit prior to hookup with an indoor unit. This enables the mobility of outdoor units without the loss of refrigerant during the move. Another function of service valves is to provide a shut-off for the possibility of a “pump-down”. During the “pump-down” process, the liquid service valve is closed and the compressor is turned on so that all of the refrigerant is pulled into and stored in the condensing unit. Thereafter, the indoor coil, expansion device, unit components, such as the fan and lines can be accessed without removing or losing the refrigerant from the system. Another function of the service valves is to provide a service port via which an out-of-system connection (such as a hose) can be made and used to evacuate refrigerant, charge (add) refrigerant, or monitor system pressure for diagnostic purposes.

When the several components (indoor and outdoor units, etc.) of the system are operatively connected, the lines between the indoor and outdoor coils are initially evacuated of air through charge ports located on both service valves. Thereafter, the service valves are opened, thus allowing pre-charged refrigerant to flow from the charged condensing unit throughout the entire system.

Prior art structures have utilized two separate valve bodies which house the liquid and suction service valves. These valve bodies are typically aligned with the connecting conduit between the indoor and outdoor units. An example of separate valve bodies for indoor and outdoor units is shown in U.S. Pat. No. 6,158,229 to Aizawa. The process of manufacturing two separate valve bodies to house the liquid and suction valves is expensive. The assembly time needed to mount both bodies onto the condensing unit is lengthy. The complexity is also increased due to the two separate valve bodies. Further, since two separate connections are made, the number of components is increased which increases the number of leak points.

A typical style of a liquid side service valve is a front-seating valve that exhibits an off-set or stepped “Z” flow path which is not conducive to low pressure drop. This pressure drop can be decreased through methods that add cost to the valve and system. The front seat valve also requires multiple rotations of its valve stem in order to be opened and closed. A typical suction side service valve is a ball-style valve that exhibits a large straight flow path. However, the cost of this style of valve is substantially higher than that of the typical front seat valve. Due to the high cost, many manufacturers opt for the lower cost front seat valve and compensate for the added pressure drop and associated efficiency losses by designing changes in other areas of the system. Ball valves provide a “soft-seal” retention of the refrigerant, rather than the metal-to-metal seal found in front seat valves. The “soft-seal” is provided by the nylon style of seal within the valve. While nylon seals provide good resistance to refrigerant permeation, they will tend to soften from heat and “creep”, thereby causing leaks.

Another obstacle with ball and front seat valves is that the charge port on the valves is always in direct communication with the system's refrigerant. In order to seal the refrigerant inside the system while its charge port cap is removed, another component, a valve core, must be installed in the charge port. The valve core can then be actuated by an appropriate fitting to allow for evacuation or addition of refrigerant as well as for pressure measurement. The required time to evacuate or add refrigerant is increased with a valve core due to its inherent flow restrictions.

A further style of service valve used in residential air-conditioning and heat pump service valve applications is a backseat valve. The system's refrigerant is sealed away from the backseat valve's charge port (by back seating the valve) so that no valve core is needed in the charge port. However, a typical backseat valve is a more expensive when compared to standard front seat valves.

### SUMMARY OF THE INVENTION

The present invention provides improvements in service valve assemblies which overcome one or more of the aforesaid obstacles met with prior art service valve assemblies.

According to one feature of the present invention, a service valve assembly, for use in a split air conditioning/heat pump system, is provided with a single valve block having a plurality of passages, a first valve and a second valve. The assembly further includes a first cavity within the block with a first valve holding passage, for conducting gaseous refrigerant inside the valve block. The first valve is operatively positioned within the first valve holding passage and includes a first through passage radially extending both through the first valve as well as from an outer surface of a first side of the block to an outer surface of a side opposite the first side. A first charging passage extends from the valve block outer surface to the first through passage. The valve block also includes a second cavity, including a second valve holding passage, for conducting liquid refrigerant within the block. The second valve is operatively interposed within the second valve holding passage and includes a second through passage extending both through the second valve as well as from the outer surface of the valve block first side to the outer surface of the opposite side. A second charging passage extends from the valve block outer surface to the second through passage. The first valve is adapted for receiving and fluidly communicating the gaseous refrigerant between the first through passage and the first charging passage. The second valve is adapted for receiving and fluidly communicating the liquid refrigerant between the second through passage and the second charging passage.

Another feature of the noted valve assembly has a first indoor unit port connected to a first end of the first through passage and a first outdoor unit port connected to a second end of the first through passage. A first service port is connected to the first charging passage and a first valve actuation port is connected to the first valve holding passage. A second outdoor unit port is connected to a first end of the second through passage and a second indoor unit port is connected to a second end of the second through passage. A second service port is connected to the second charging passage and a second valve actuation port is connected to the second valve holding passage. Yet another feature has the first and second actuation ports formed integrally with the valve block.

Still another feature of the noted service valve assembly has a first charging valve cap for covering the first service port and a second charging port cap for covering the second service port. A first valve cap covers the first valve actuation port and a second valve cap covers the second valve actuation port. Another aspect of the noted assembly has the first through passage, the first valve holding passage, the second through passage, and the second valve holding passage being circular in cross section and of differing diametral extent.

A further feature of the noted service valve assembly has the first charging passage and the first valve holding passage being oriented perpendicularly relative to the first through passage. Also, the second charging passage and the second valve holding passage can be oriented perpendicularly relative to the second through passage. Still another feature has the valve block with a surface having at least one recess for receiving a fastening member for securing the assembly onto a component of the system.

Still yet another feature of the noted service valve has the first through passage being linear. Another feature has the second through passage being linear. Still another has both the first and second through passages being linear. Another aspect has the first valve with at least one seal for retaining gaseous refrigerant with the first plurality of passages. This at least one seal can be comprised of an elastomeric material.

According to yet another aspect of the invention, the first valve can be a plug valve. Still according to this aspect of the invention, the plug valve has a plug body capable of housing a series of removable stems with through holes of varying diameters. Still the plug valve can have a seal for retaining refrigerant with the first through passage. Still yet, the plug valve can have an isolated charge port.

A further feature of the noted valve assembly has the first and second valves being plug valves. Another feature has the plug valves with different sizes. Still another feature has the plug valves having a valve stem which can be replaced with a substitute valve stem having an alternate sized through passage. Yet another feature has each of the plug valve with an isolated charge port. Yet another aspect of the invention has the first valve as a plug valve and the second valve as a front seat valve. Further features and advantages of the present invention will become apparent to those skilled in the art upon review of the following specification in conjunction with the accompanying drawings.

### BRIEF DESCRIPTION OF THE DRAWINGS

FIG. 1 is a perspective view of one embodiment of the service valve assembly according to the present invention.

FIG. 2 is a top plan view of the service valve assembly shown in FIG. 1.

FIG. 3 is a sectional view taken along line 3-3 in FIG. 2.

FIG. 4 is a side view of the service valve assembly of FIG. 1.

FIG. 5 is a sectional view taken along line 5-5 in FIG. 4.

FIG. 6 is a schematic of the service valve assembly integrated into a split air conditioning/heat pump system.

FIG. 7a is a perspective view of a valve stem used in the present invention.

FIG. 7b is a sectional view taken along line 7b-7b in FIG. 7a.

FIG. 7c is a sectional view taken along line 7c-7c in FIG. 7a.

FIG. 7d is a further perspective view of the valve stem shown in FIG. 7a with the addition of a directional cap.

FIG. 7e is a side view, with phantom seal groove lines shown, of the valve stem of the present invention.

FIG. 8 is an elevated view of an end cap used for sealing an opening in the service valve assembly.

FIG. 9 is an elevated view of a rotational restriction member used for limiting the extent of rotational movement when manually operating the valve stem.

FIG. 10 is an elevational view of another embodiment of the service valve assembly according to the present invention.

FIG. 11 is a side view of the service valve assembly shown in FIG. 10.

FIG. 12 is a sectional view taken along line 12-12 in FIG. 11.

FIG. 13 is an elevational view of a further embodiment of the service valve assembly according to the present invention.

FIG. 14 is an elevational view of an additional embodiment of the service valve assembly according to the present invention.

FIG. 15 is a top plan view of the service valve assembly shown in FIG. 14.

FIG. 16 is a sectional view taken along line 16-16 in FIG. 15.

### DETAILED DESCRIPTION OF THE PREFERRED EMBODIMENTS

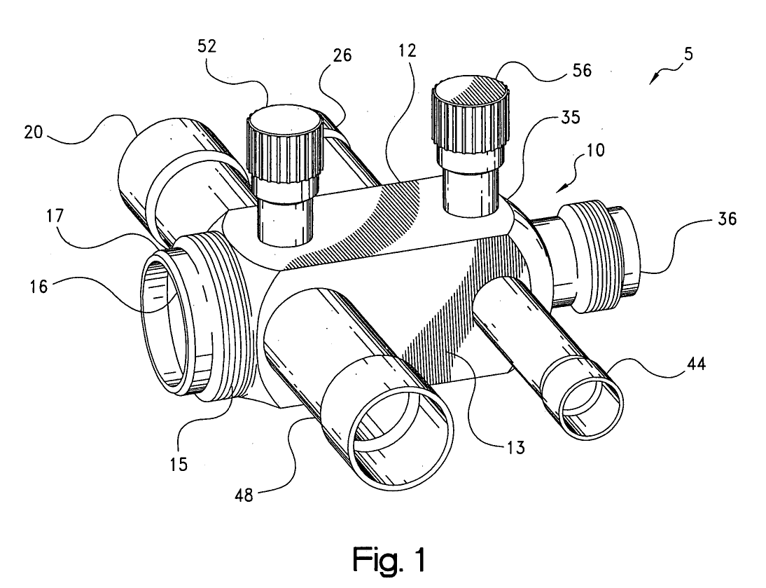

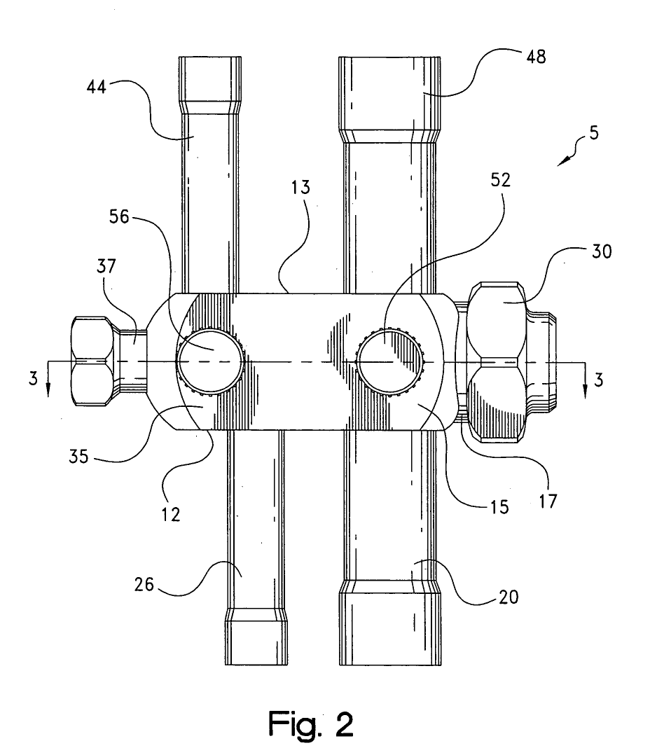

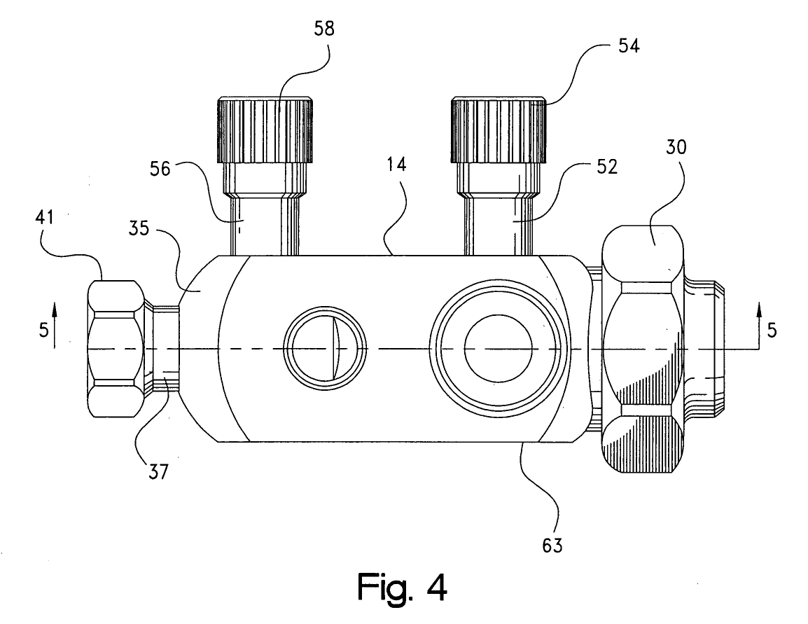

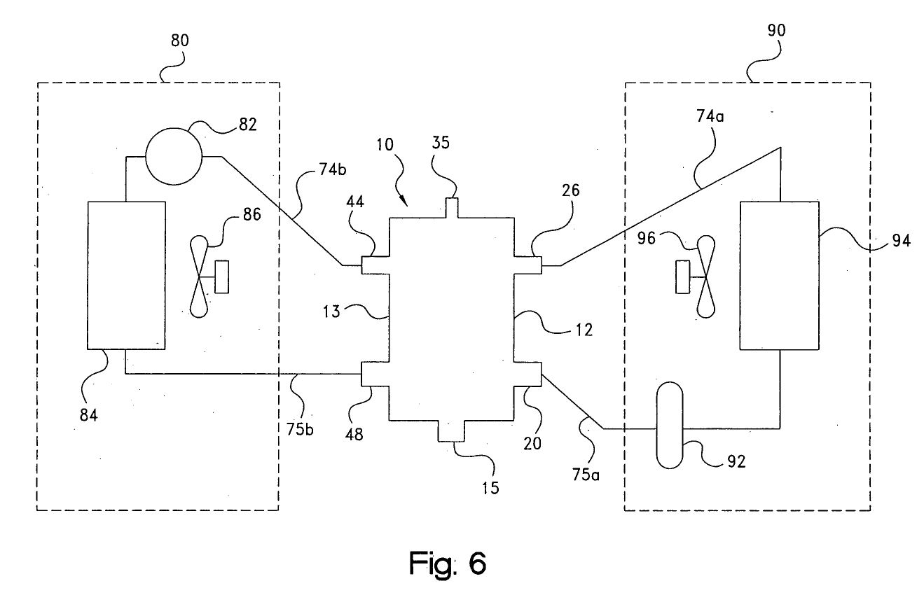

Referring first to FIGS. 1-6, one embodiment dual body service valve assembly 5 is shown. Service valve assembly 5 has a valve body 10 that is preferably machined from bar stock, e.g. square bar stock, and provides fluid connections for an indoor unit 80 (FIG. 6) and an outdoor unit 90 used, for example, in a residential split air-conditioning/heat pump system. As is well known in the art, service valve assemblies provide connections between a charging apparatus and a condensing unit, as well as between outdoor and indoor units. While functioning as an air-conditioning system, outdoor unit 90 is primarily comprised of a compressor 92, an outdoor coil 94 and a fan 96. Indoor unit 80 is primarily comprised of an expander 82, an indoor coil 84 and a fan 86. Once installed, outdoor unit 90 is connected with indoor unit 80 by a high-pressure line 74a, 74b and a low-pressure line 75a, 75b that convey a refrigerant medium.

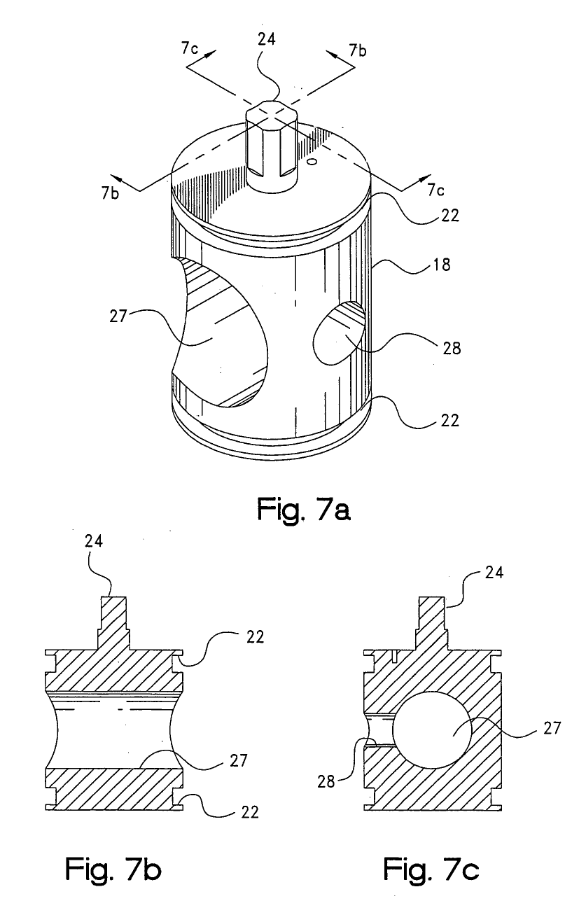

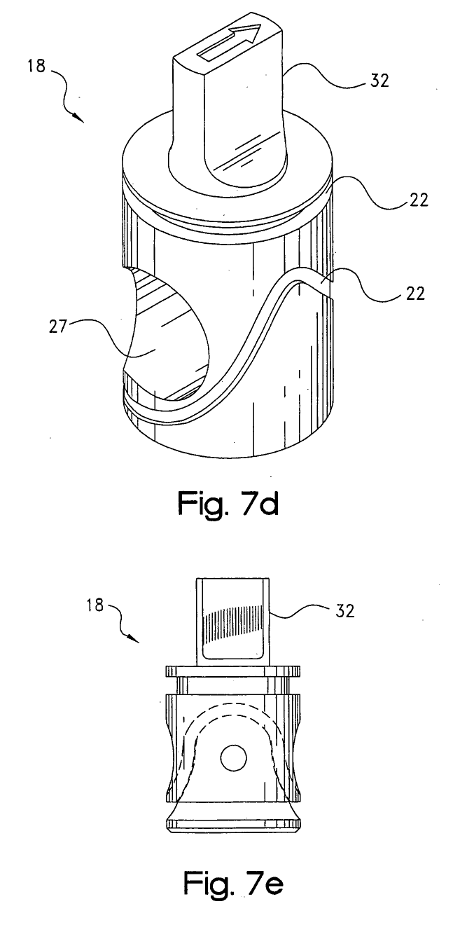

Valve body 10 has multiple adjacent sides that are positioned to most directly communicate with other components in the system. For example, since valve body 10 is providing a connection between outdoor unit 90 and indoor unit 80, conduit 74a, that attaches same to outdoor unit 90, mates with a first side 12 of valve body 10 and conduit 74b that attaches same to indoor unit 80 mates with a second side 13 of valve body 10. A suction end 15 is located on one axial end of valve body 10, with a liquid end 35 being located on the opposite axial end thereof. Suction end 15 incorporates a suction valve cavity 16 that also includes machined interconnectable passages within valve body 10. At its furthest axial end, suction valve cavity 16 is structured to receive a suction service valve, or valve plug 18, shown in FIG. 7a. Valve body 10, at suction end 15, also includes a formed suction end port 17 that can be threaded to receive a correspondingly threaded cap 30.

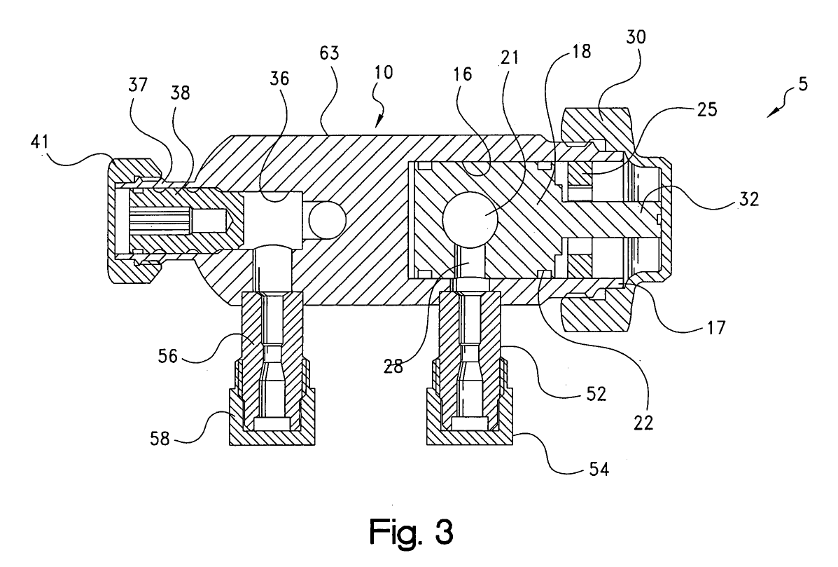

Likewise, liquid end 35 incorporates a liquid valve cavity 36 that also includes machined interconnectable passages with valve body 10. Liquid valve cavity 36, and its passages, are not connected with suction valve cavity 16, at its associated passages. At its furthest axial end, liquid valve cavity 36 is structured to receive a liquid service valve that can take, if so desired, a form similar to that of valve plug 18, or alternatively a liquid service valve, or valve stem 38, as shown in FIG. 3. If used, valve stem 38 can take the form of either a front seating valve or other well know valves used in the noted outdoor residential equipment. Valve body 10, at liquid end 35, also includes a formed liquid end port 37 that can be threaded to receive a correspondingly threaded cap 41.

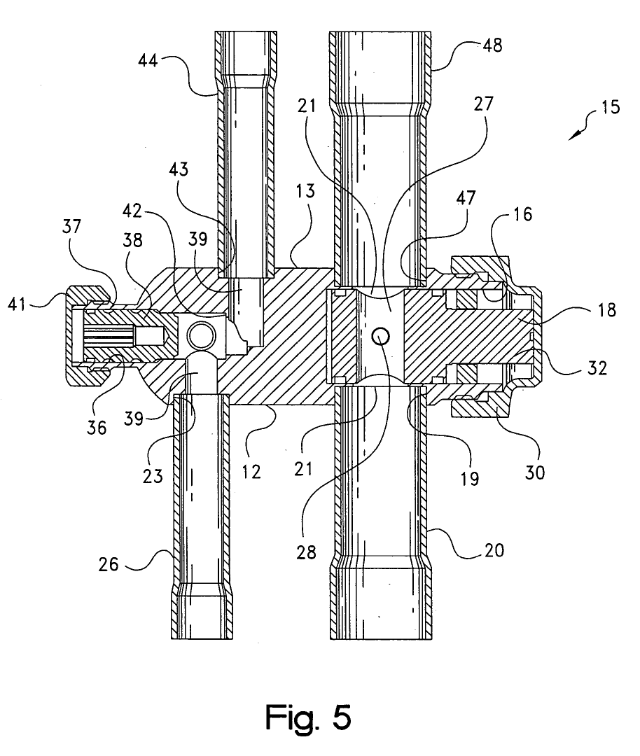

Suction end cavity 16 includes a radial through passage 21 that extends from first side 12 to second side 13. As shown in FIG. 5, suction through passage 21 is linear or in-line so that it can receive valve plug 18. Similarly, liquid end cavity 36 has a radial through passage 39 that also extends from first side 12 to second side 13. However, in the embodiment shown in FIG. 5, liquid through passage 39 is not linear, but is stepped or off-set so that the machined surface of passage 39, within cavity 36, can provide a front seat, sealing shoulder 42 for valve stem 38. As referenced earlier, in the alternative, through passage 39 could be structured to be linear, like passage 21, and also receive a valve plug 18. In that latter case, liquid end 35 could be substantially a mirror image of the shape of suction end 15. Of course, suction passages and their valves are typically larger than the liquid passages and their valves since the suction passages are conveying gaseous rather than liquid refrigerant.

Valve body 10 interfaces with outdoor unit 90 via an orifice 19 (FIG. 5) on first side 12 that connects with an inlet tube 20 which conveys gaseous refrigerant to outdoor unit 90. Valve body 10 further interfaces with outdoor unit 90 via another orifice 23 on first side 12 that receives a condensing side tube 26 which receives liquid refrigerant from outdoor unit 90 during the working cycle. This direction of fluid flow would, of course, be reversed during the heating cycle. Valve body 10 has a side mounting surface 63 that has at least one mounting hole (not shown) machined into surface 63 so that valve body 10 can be mounted onto, for example, the condensing unit.

Valve body 10 further has two more orifices (FIG. 5) located on second side 13 that provide an interface with indoor unit 80. A first orifice 43 receives an inlet tube 44 that conveys liquid refrigerant to indoor unit 80 and a second orifice 47 receives a suction, or low-pressure side, tube 48 that accepts gaseous refrigerant from indoor unit 80. It should be noted that tubes 20, 26, 44 and 48 can be permanently attached to valve body 10, e.g. with brazed joints or formed integrally with valve body 10.

Suction end conduits 20, 48 are aligned on opposite sides 12, 13 of valve body 10, and are positioned at the same axial end, namely suction end 15. A suction end charge port 52 is also positioned at suction end 15 on a body side surface 14 between conduit 20 and 48. A removable charge port cap 54 is attached to charge port 52 and seals refrigerant medium inside suction end 15 of service valve assembly 5. Suction service valve 18 can fluidly communicate with charge port 52 via a radial side passage 28, as well as suction conduit 20, 48 via a radial through passage 27.

Similarly, liquid end conduit 26, 44 are positioned on opposite sides 12, 13 of valve body 10, and are located at the same axial end, namely liquid end 35. A liquid end charge port 56 is also positioned at liquid end 35 on side surface 14 between conduit 26 and 44. As previously referenced, since the suction side service valve 18 and conduit 20, 48 convey gaseous (lower pressure) refrigerant, valve 18 is shown substantially larger than the liquid side service valve 38. A removable liquid end charge port cap 58 is attached to charge port 56 and seals refrigerant medium inside liquid end 35 of service valve assembly 5.

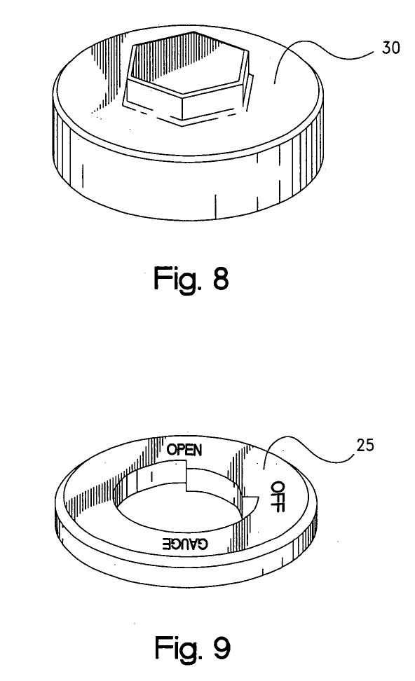

Referring now to FIGS. 7-9, suction side service valve 18 is generally cylindrical and has major radial through passage 27 and an intersecting minor radial side passage 28 integrated therewithin. At least one or preferably two O-ring grooves 22 are positioned on at least one axial end of valve 18 and receive O-rings (not shown) whose function is the sealing of valve 18 within its receiving cavity 16 in valve body 10. These O-rings can be comprised of known elastomeric materials that act as good sealants for retarding refrigerant progression while withstanding its deleterious effects. A valve actuation stem 24 is located on one longitudinal end and is used for rotating service valve 18 to open and closed positions. A direction-indicating cap 32 is placed on top of stem 24 and provides an indication of the position of valve 18. A rotational restriction member 25 is pressed into cavity 16 on top of suction service valve 18 and limits the extent of the rotation of stem 24. For example, if service valve 18 has an isolated charge port orifice (as is shown at 28 in FIG. 7a), the valve rotation will be restricted to 270°. If service valve 18 does not have an isolated charge port, the rotational extent will be restricted to 90°. When operatively received within its valve cavity 16, suction valve actuation stem 24 and directional cap 32 protrude outwardly from suction end port 17. As is best shown in FIG. 5, major passage 27 extends through service valve 18 and fluidly connects inlet tube 20 with suction tube 48 when service valve 18 is rotated for gaseous refrigerant passage. Isolated charge port orifice or minor passage 28 is formed within service valve 18 and extends from the outer surface of service valve 18 to major passage 27. As is best seen in FIG. 3, minor passage 28 aligns with suction end charge port 52 when properly rotated, with the latter serving for charging and diagnostic purposes.

The seal(s), or O-ring(s) (not shown), within suction service valve grooves 22 prevent refrigerant from reaching suction end charge port 52 when service valve 18 is rotated such that minor passage 28 is not aligned with charge port 52. The seal(s) also prevent refrigerant from reaching inlet tube 20 when major passage 27 is not aligned with inlet tube 20 and suction tube 48. This non-alignment valve position is common during shipment of outdoor unit 90 before installation or after a pump down procedure when it is desired to prevent refrigerant flow between the outdoor and indoor units. Suction valve port end 17 is preferably permanently deformed to capture rotational restriction member 25 and suction service valve 18. Cap 30 encapsulates suction service valve 18, as a final seal against leakage, and can be threadably connected with suction valve port 17.

It should again be noted that liquid end 35 could use a service valve similar to suction service valve 18. This of course would alter the design of valve body 10 as shown in FIGS. 1-5. Specifically, liquid through passage 39 would be linear, like suction through passage 21. Alternatively, as shown in FIGS. 1-5, liquid service valve 38 can be used. Liquid valve port 37 is preferably permanently deformed to capture liquid service valve 38. Preferably the external surface of liquid valve port 37 is threaded to mate with corresponding threads on a cap 41. As discussed above, liquid service valve 38 is shown as a front-seating valve. As is well known in the art, a front-seating valve is actuated by multiple rotational threading that produces linear movement. Specifically, valve 38 is threaded into liquid valve cavity 36 so it moves linearly in or out of liquid through passage 39 with manual rotation. When completely threaded into passage 39, the distal end of valve 38 engages machined shoulder 42 which in turn prevents refrigerant from passing from one end of passage 39 to the other.

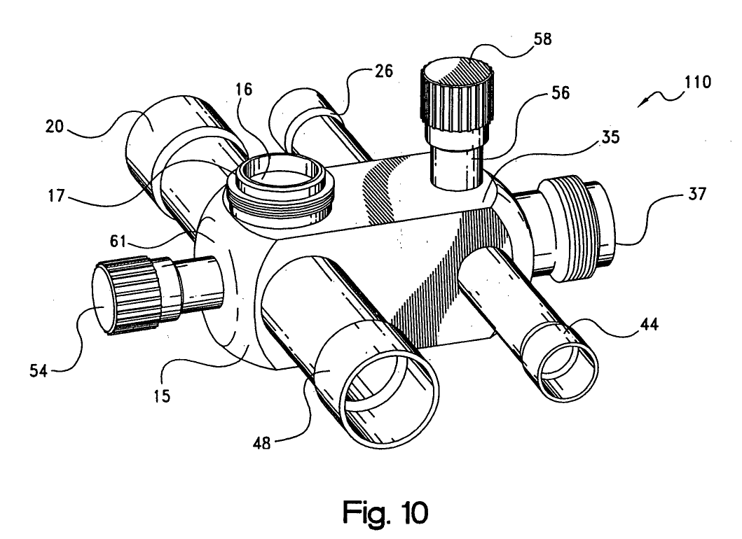

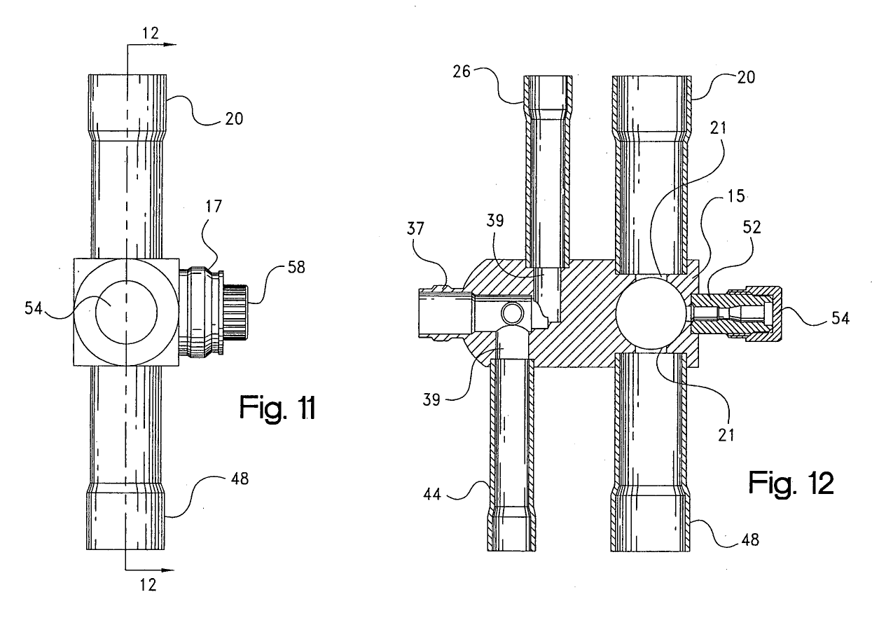

FIGS. 10-12 show another embodiment valve body 110 in which liquid valve port 37 is once again formed or machined directly onto one end of the valve body, similar to valve body 10 discussed above. Suction side valve end 15 has been modified from that of valve body 10 such that the placement of charge port 52 and suction valve port 17 have been reversed. As discussed above, suction valve port 17 once again houses actuation stem 24 of valve 18, along with rotational restriction member 25 and cap 30. As with embodiment 10, suction end charge port 52 is positioned between conduit 20 and 48, specifically at 90° from through passage 21. Additionally, valve port 17 is also positioned at 90° from through passage 21. The operation and assembly of suction service valve 18 is identical to embodiment 10 discussed above. It should also be noted that valve body 110 could be formed with suction valve port 16 being part of one-piece valve body 110.

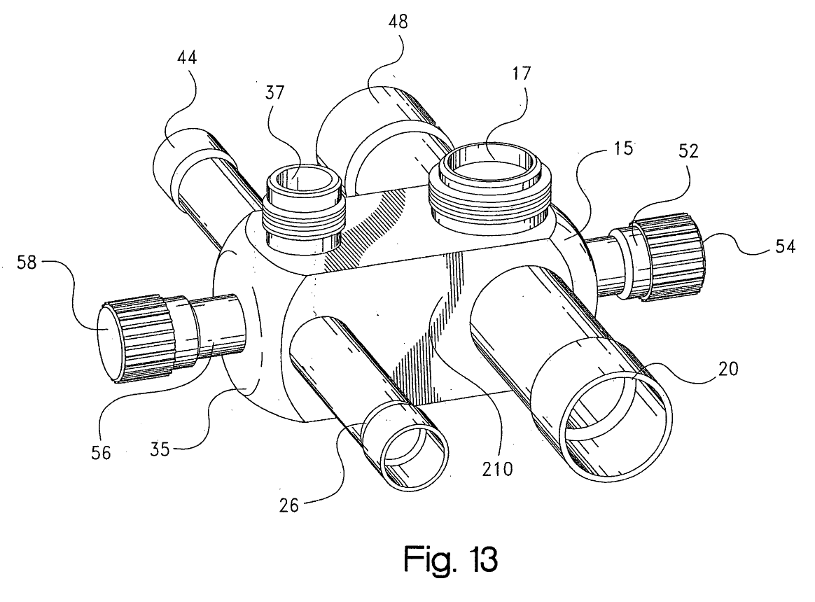

FIG. 13 details a further embodiment valve body 210 in which suction and liquid valve ports 17, 37 are individually machined components brazed onto valve body 210 during assembly. Suction end 15 is identical to suction end of valve body 110 shown in FIG. 10. Liquid end 35 has been modified from valve body 110 in that the location of liquid valve port 37 and liquid charge port 56 are reversed. The cavity within liquid end 35 once again receives liquid service valve 38 similar to that of valve body 10. Once again, suction end charge port 52 is positioned at 90° from through passage 21 (not shown). Additionally, suction end port 17 is also positioned at 90° from through passage 21. Liquid end charge port 56 is positioned on a surface between condensing side tube 26 and inlet tube 44 and is oriented at 90° from passage 39 (not shown). Liquid end port 37 is also oriented at 90° from passage 39. The operation and assembly of suction service valve 18 is identical to embodiment 10 discussed above. Embodiment 210 discloses a three-piece (valve body 210, suction valve port 16 and liquid valve port 36) construction, but a one-piece construction could be employed by integrally forming valve body 210 with the additional ports 16, 36, as is the case with valve body 10.

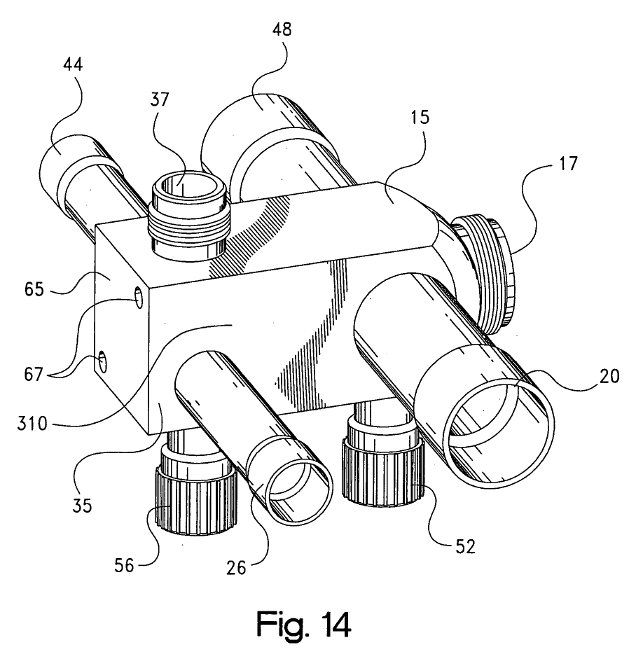

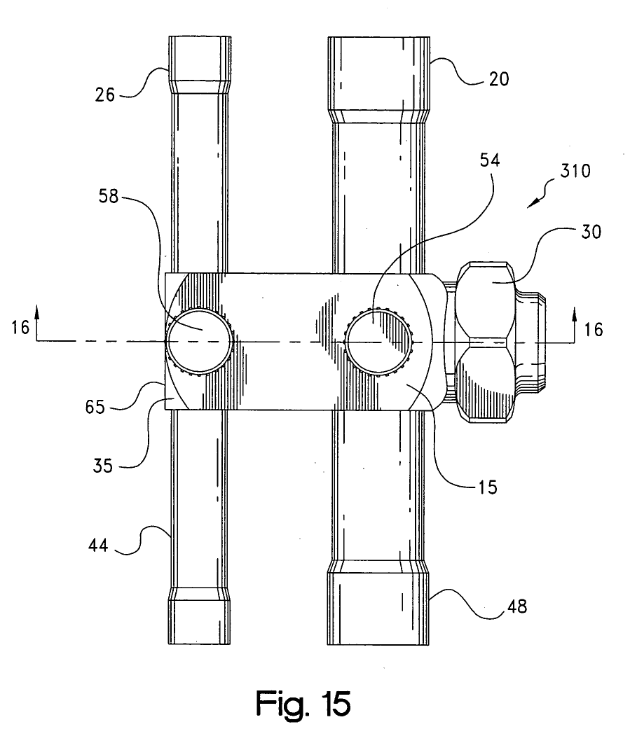

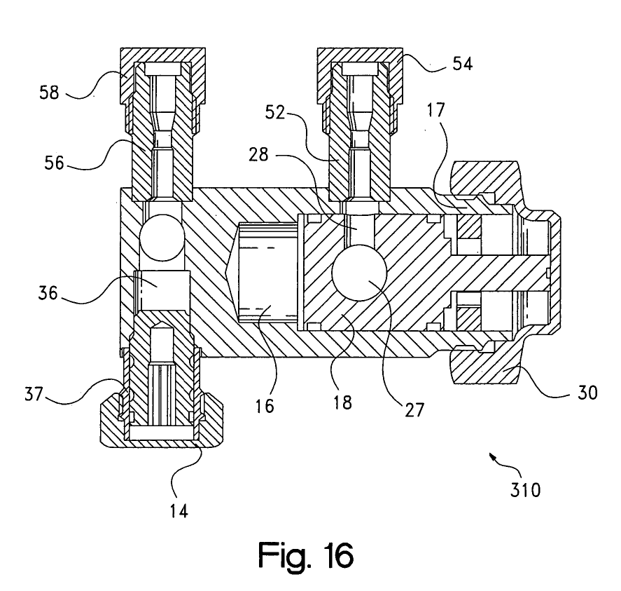

FIGS. 14-16 detail yet an additional embodiment valve body 310 in which suction valve port 17 is machined directly into valve body 310 (as is the case in previously discussed valve body 10). Inlet tube 20 and suction tube 48 are also similar to those of previously discussed valve body 10. Liquid end 35 has been altered so that a mounting surface 65 is available at the axial end opposite suction end 15. At least one mounting hole 67 is machined into mounting surface 65 so that valve body 310 can be mounted in an upright manner. When compared with valve body 10, liquid valve port 37 has been moved from the furthermost axial surface, mounting surface 65, of the valve body to an adjacent surface located between condensing side tube 26 and inlet tube 44. This embodiment shows liquid valve port 37 as a separate machined port that is preferably brazed onto valve body 310. Suction end 52 and liquid end 56 charge ports are similar to those shown with valve body 10. As with every other embodiment, suction end port 17 and suction end charge port 52 are positioned at 90° from suction through passage 21 (not shown). Similarly, liquid end port 37 and liquid end charge port 56 are also positioned at 90° from liquid through passage 39 (not shown).

It should be noted that each one of valve body embodiments 110, 210 and 310 can utilize valve 18 as a substitute for the shown liquid service valve 38. In each such case, liquid through passage 39 would take the form of a linear passage similar to suction through passage 21 and receive valve plug 18.

It should be noted that the present invention is not limited to the specified preferred embodiments and principles. Those skilled in the art to which this invention pertains may formulate modifications and alterations to the present invention. These changes, which rely upon the teachings by which this disclosure has advanced, are properly considered within the scope of this invention as defined by the appended claims.

What is claimed is:

1. A service valve assembly, for a split air-conditioning and heat pump system, said assembly comprising:
a service valve block having a plurality of interconnected side surfaces, a first cavity, a first set of orifices in parallel opposed side surfaces of said service block and perpendicular to said first cavity, a second cavity, a second set of orifices in parallel opposed side surfaces of said service block and perpendicular to said second cavity;
a first valve, operatively positioned within said first cavity, including a first set of passages having a first main passage extending through said first valve from an inlet located at a first one of said first set of orifices to an outlet located at a second one of said first set of orifices, and a first minor passage extending from a third one of said first set of orifices to said main passage, with said first valve serving to direct a refrigerant medium through said first set of passages; and
a second valve, operatively positioned within said second cavity, including a second set of passages having a second main passage extending through said second valve from an inlet located at a first one of said second set of orifices to an outlet located at a second one of said second set of orifices, and a second minor passage extending from a third one of said second set of orifices, with said second valve serving to direct said refrigerant medium through said second set of passages.

2. A service valve assembly, for a split air-conditioning and heat pump system, said assembly comprising:
a multi-sided service valve block having:
a first axial end;
a second axial end;
a first set of orifices and a first cavity located at said first axial end;
a second set of orifices and a second cavity, located at said second axial end;
a first side surface, at said first axial end, having a first side surface orifice and a first valve holding passage extending axially inwardly therefrom;
a second side surface, extending from said first axial end to said second axial end, located perpendicular to said first side surface, having a plurality of bores for receiving fasteners;
a third side surface located perpendicular to said first and second side surfaces, having a liquid refrigerant inlet orifice and a gaseous refrigerant outlet orifice located therein;
a fourth side surface located perpendicular to said first and third side surfaces, having a liquid charge port orifice and a gaseous charge port orifice located therein;
a fifth side surface located perpendicular to said first, second and fourth side surfaces, having a liquid refrigerant outlet orifice and a gaseous refrigerant inlet orifice located therein; and
a sixth side surface located at said second axial end, located perpendicular to said second, third, fourth, and fifth side surfaces, having a second side surface orifice therein, and a second valve holding passage extending axially inwardly therefrom;
a first valve body operatively positioned within said first valve holding passage, including a first set of passages having:
a main liquid refrigerant passage radially extending through said first valve body from said liquid refrigerant inlet orifice to said liquid refrigerant outlet orifice; and
a first minor charge passage, perpendicular to said main liquid refrigerant passage, extending from said liquid charge port orifice to said main liquid refrigerant passage; said first set of passages controlling the flow of liquid refrigerant within said main liquid refrigerant passage and said first minor charge passage; and
a second valve body, operatively positioned within said second valve holding passage, including a second set of passages having:
a main gaseous refrigerant passage radially extending through said second valve body from said gaseous refrigerant inlet orifice to said gaseous refrigerant outlet orifice; and
a second minor charge passage, perpendicular to said main gaseous refrigerant passage, extending from said gaseous charge port orifice to said main gaseous refrigerant passage, said second set of passages controlling the flow of gaseous refrigerant within said main gaseous refrigerant passage and said second minor charge passage.

3. The service valve assembly as in claim 2 wherein said main liquid refrigerant passage extends linearly through said service valve block.

4. The service valve assembly as in claim 2 wherein both said main liquid refrigerant passage and said main gaseous refrigerant passage extend linearly through said service valve block.

5. A service valve assembly, for use in a split air conditioning/heat pump system, said assembly comprising:
a valve block having a plurality of passages;
a first cavity including a first valve holding passage, for conducting gaseous refrigerant within said block;
a first valve, operatively positioned within said first valve holding passage, including a first through passage radially extending both through said first valve as well as from an outer surface of a first side of said block to an outer surface of a side opposite said first side;
a first charging passage extending from said valve block outer surface to said first through passage;
a second cavity, including a second valve holding passage, for conducting liquid refrigerant within said block;
a second valve, operatively interposed within said second valve holding passage including a second through passage extending both through said second valve as well as from the outer surface of said valve block first side to the outer surface of said opposite side;
a second charging passage extending from said valve block outer surface to said second through passage;
said first valve being adapted for receiving and fluidly communicating said gaseous refrigerant between said first through passage and said first charging passage; and
said second valve being adapted for receiving and fluidly communicating said liquid refrigerant between said second through passage and said second charging passage.

6. The service valve assembly as in claim 5 further comprising:
a first indoor unit port connected to a first end of said first through passage;
a first outdoor unit port connected to a second end of said first through passage;
a first service port connected to said first charging passage;
a first valve actuation port connected to said first valve holding passage;
a second outdoor unit port connected to a first end of said second through passage;
a second indoor unit port connected to a second end of said second through passage;
a second service port connected to said second charging passage; and
a second valve actuation port connected to said second valve holding passage.

7. The service valve assembly as in claim 6 further comprising:
a first charging port cap for covering said first service port;
a second charging port cap for covering said second service port;
a first valve cap for covering said first valve actuation port; and
a second valve cap for covering said second valve actuation port.

8. The service valve assembly as in claim 6 wherein said first and said second valve actuation ports are formed integrally with said valve block.

9. The service valve assembly as in claim 5 wherein said first through passage, said first valve holding passage, said second through passage, and said second valve holding passage are circular in cross section and of differing diametral extents.

10. The service valve assembly as in claim 5 wherein said first charging passage and said first valve holding passage are oriented perpendicularly relative to said first through passage.

11. The service valve assembly as in claim 5 wherein said second charging passage and said second valve holding passage are oriented perpendicularly relative to said second through passage.

12. The service valve assembly as in claim 5 wherein said valve block has a surface with at least one recess for receiving a fastening member for securing said assembly onto a component of said system.

13. The service valve assembly as in claim 5 wherein said first through passage is linear.

14. The service valve assembly as in claim 5 wherein said second through passage is linear.

15. The service valve assembly as in claim 5 wherein said first and said second through passages are both linear.

16. The service valve assembly as in claim 5 wherein said first valve has at least one seal for retaining gaseous refrigerant within said first plurality of passages.

17. The service valve assembly as in claim 16 wherein said at least one seal is comprised of an elastomeric material.

18. The service valve assembly as in claim 5 wherein said first valve is a plug valve.

19. The service valve assembly as in claim 18 wherein said plug valve is comprised of a plug body capable of housing a series of removable stems having through holes of varying diameters.

20. The service valve assembly as in claim 18 wherein said plug valve has a seal for retaining refrigerant within said first through passage.

21. The service valve assembly as in claim 18 wherein said plug valve has an isolated charge port.

22. The service valve assembly as in claim 5 wherein said first and second valves are both plug valves.

23. The service valve assembly as in claim 22 wherein said first and second plug valves are of different sizes.

24. The service valve assembly as in claim 22 wherein each of said plug valves has a valve stem which can be replaced with a substitute valve stem having an alternate sized through passage.

25. The service valve assembly as in claim 22 wherein each of said plug valves has an isolated charge port.

26. The service valve assembly as in claim 5 wherein said first valve is a plug valve and said second valve is a front seat valve.

27. An improved service valve block, for use in a split air conditioning/heat pump system, comprising:
a first cavity defining a first plurality of interconnected passages for conducting gaseous refrigerant within said block including:
a first through passage radially extending from an outer surface of a first side of said block to an outer surface of a side opposite said first side;
a first charging passage extending from said valve block outer surface to said first through passage; and
a first valve holding passage extending from said valve block outer surface to said first through passage; and
a second cavity, defining a second plurality of interconnected passages for conducting liquid refrigerant within said block, including:
a second through passage radially extending from said outer surface of said block first side to said outer surface of said opposite side;
a second charging passage extending from said valve block outer surface to said second through passage; and
a second valve holding passage extending from said valve block outer surface to said second through passage.

28. A service valve assembly, for use in a split air conditioning/heat pump system, said assembly comprising:
a valve block having:
a first cavity defining a first plurality of interconnected passages for conducting gaseous refrigerant within said block including:
a first through passage radially extending from an outer surface of a first side of said block to an outer surface of a side opposite said first side;
a first charging passage extending from said valve block outer surface to said first through passage; and
a first valve holding passage extending from said valve block outer surface to said first through passage;
a second cavity defining a second plurality of interconnected passages for conducting liquid refrigerant within said block including:
a second through passage extending from an outer surface of said valve block first side to said outer surface of said opposite side;
a second charging passage extending from said valve block outer surface to said second through passage; and
a second valve holding passage extending from said valve block outer surface to said second through passage;
a first valve operatively positioned within said first valve holding passage, including a through passage radially extending through said first valve being adapted for receiving and fluidly communicating said gaseous refrigerant between said first through passage and said first charging passage; and
a second valve operatively interposed within said second valve holding passage including a second through passage extending through said second valve being adapted for receiving and fluidly communicating said liquid refrigerant between said second through passage and said second charging passage.

29. The service valve assembly as in claim 28 wherein a first valve actuation port connected to said first valve holding passage is integral with said valve block and a second valve actuation port connected to said second valve holding passage is also integral with said valve block.

30. The service valve assembly as in claim 28 wherein said first charging passage and said first valve holding passage are oriented perpendicularly relative to said first through passage.

31. The service valve assembly as in claim 28 wherein said second charging passage and said second valve holding passage are oriented perpendicularly relative to said second through passage.

32. The service valve assembly as in claim 28 wherein said first through passage is linear.

33. The service valve assembly as in claim 28 wherein said second through passage is linear.

34. The service valve assembly as in claim 28 wherein said first and said second through passages are both linear.

35. The service valve assembly as in claim 28 wherein said first valve is a plug valve.

36. The service valve assembly as in claim 28 wherein said first and second valves are both plug valves.
